(19) United States
(12) Patent Application Publication
(10) Pub. No.: US 2011/0035317 A1
(43) Pub. Date: Feb. 10, 2011

(54) SEEDLESS ANTI PHISHING AUTHENTICATION USING TRANSACTION HISTORY

(76) Inventors: Mark Carlson, Half Moon Bay, CA (US); Patrick L. Faith, Pleasanton, CA (US); Ayman Hammad, Pleasanton, CA (US); Shalini Mayor, Foster City, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/787,788

(22) Filed: May 26, 2010

Related U.S. Application Data
(60) Provisional application No. 61/232,364, filed on Aug. 7, 2009.

(51) Int. Cl. H04L 9/32; G06Q 40/00

(52) U.S. Cl. 705/40; 726/7; 705/44

(57) ABSTRACT

Systems and methods for providing authentication verification for a correspondence and other messages are disclosed. A link, such as a uniform resource locator (URL) link, is placed in a correspondence and sent to a user. When the user follows the link, a list of personal transaction data from the user's credit card or other financial account is presented. Because the personal transaction data is substantially private to user and his or her financial institution and card servicing company and not known to the public, the recipient can be assured that the message truly came from the financial institution or the card servicing company and not from a phisher.

### CROSS-REFERENCES TO RELATED APPLICATIONS

This application claims the benefit of U.S. Provisional Application No. 61/232,364, filed Aug. 7, 2009, hereby incorporated by reference in its entirety for all purposes.

### BACKGROUND

1. Field of the Invention

Systems and methods for verifying the authenticity of a message is disclosed. Specifically, an anti-phishing solution for unsecured correspondence in which dynamic credit or other payment card transaction history is presented is disclosed.

2. Discussion of the Related Art

The numbers of attackers gaining access to users' financial accounts has grown over the years to alarming rates. Many of these identity thefts are occurring over unsecured messaging channels, which provide few easy ways for a user to authenticate if the message is genuine or not.

“Phishing” is attempting to acquire sensitive information, such as usernames, passwords, credit card numbers, etc. by masquerading as a trustworthy entity in electronic communications. Phishing can take the form of a correspondence faked to look as though it were from a legitimate bank or other trusted institution. The fake correspondence encourages a user to follow an attached or embedded link and enter his or her username and password into a login page. The login page is, of course, a fake web page at a different address than that of the legitimate bank or institution. Once the user's username and password are entered into the fake login page, the con artist (i.e. the “phisher”) who set up the fake web page and sent the fake message can use the username and password on the legitimate bank's web site to steal the user's funds.

In some instances, scam artists closely replicate the look and feel of a legitimate business's official correspondence to its customers, right down to the logo, colors, font, office address, and other features. Features within digital correspondence are often easier to duplicate than in non-digital, analog correspondence because digital features can be reproduced exactly, down to the exact bit, while analog copies are invariably inferior to the original. The result is that even a very astute user may not realize that an email or other digital electronic communication is from a phisher and be tricked into revealing his or her username and password.

While significant investments have gone into strengthening the authentication of the user to prevent phishing, authenticating the website or application to the user has also become critical. Given the growth in alternative correspondence methods, e.g., instant messaging (IM) and short message service (SMS), current systems and methods for authentication are inadequate in many cases.

To authenticate a web site or application to a user such that the user knows that the website or application is genuine, some legitimate businesses' web sites show a picture to the user that the user had preselected during setup of his account. If, when logging onto an account, the picture is different than the one that the user selected previously, then the user can recognize (consciously or unconsciously) that something is out of the ordinary. A changed picture indicates that the web site is not the same web site that the user has visited on other occasions and therefore is a fake site.

Unfortunately, the above method requires a pre-selection of a picture by the user during enrollment or setup of the web site, which adds to the hassle of signing up for a web site. Many users dislike and resent having to select and remember yet another thing, besides a username and password, for a particular website. Furthermore, a user's selected picture is static and stays the same until the user selects a different picture. Once a user's selected picture is known, phishers can display the picture in their web sites or correspondence in order to lure a user into believing that the site or correspondence is genuine.

### SUMMARY

There is a need to consider anti-phishing mechanisms over any unsecured correspondence that a user could receive. A proposed solution includes a seedless anti-phishing method that can be used over unsecured digital channels such as email, SMS, IM, and even paper mail. Systems and methods are disclosed for providing authentication verification for correspondence and other messages.

Generally in some embodiments, links, such as uniform resource locators (URLs), are sent with messages to recipients. Each recipient has a substantially private account, such as a credit card account. If the recipients of the messages doubt the authenticity of the messages, then the recipients can follow the links to custom verification pages which shows details a few, random transactions that the respective recipient has recently made using the account. The transactions that are displayed can be varied each time the recipient visits or refreshes the URL.

In other embodiments, resources, such as sound files, can be correlated to transactions in the message recipients' accounts. The resources, such as sounds, are shown, played, or otherwise presented to the recipient right up front (i.e. automatically) with the message or in response to the user selecting the resource to be presented. Correlating a sound, video, image, or other resource and then presenting the correlated resource can mask the exact details of a transaction from someone who is not supposed to receive the message, such as an eavesdropper, intercepting party, or misaddressed recipient.

The technical advantages of these solutions are many. They can protect a wider audience than many anti-phishing mechanisms because overt sign ups by users are not required. Because overt sign ups are not required, and thus “seedless,” more users will be protected from phishing. Furthermore, this solution can be very effective in electronic communications, as transaction data from a transaction initiated just seconds ago can be used for verification. The solutions can be used for paper correspondence as well. A printed code or link can be entered by a user into a web browser, and the link can show the transactions. Not only can these solutions be used for messages from the bank or institution that manages the account, but they can be used for senders that are wholly unrelated to the account and for messages that are completely unrelated to the transactions. For example, a message from a trusted charitable organization can be paired with a link so that the recipient can confirm that it is a real charity. The content of the message invite the recipient to a local cleanup effort at a beach, content which is entirely unrelated to any transaction the recipient of the message has made.

One embodiment is directed to a method of providing authentication verification for a message. The method includes providing a unique link, the link to be sent with a message to a user of an account, selecting at least one transaction from a plurality of transactions of the account, the account being substantially private to the user, and presenting a resource in response to a selection of the link. The resource corresponds to the selected transaction, thereby enabling the user to recognize or otherwise verify the authenticity of the message.

The transactions can be selected randomly from an account using pseudo-random generators. Pseudo-random generators are available in many computers and accessible through various programming languages.

The transactions can be selected from a subset of the transactions. For example, recurring auto payments, such as those to pay a phone bill, can be excluded from the pool of transaction from which the transactions are selection. As another example, only payments over $20 made in the last week are included in the transaction pool.

The type of resource (e.g. web page, image, sound, or video file) to be shown, played, or otherwise presented can also be determined based on the transaction. For example, a purchase from a pet food store can result in a cat's “meow” sound, while a purchase of medicine from a pharmacy can result in a more subdued web page with a simple line item listing the transaction amount.

If the user refreshes or replays a correlated resource, a different correlated image, sound, or video can be presented. For example, upon a refresh a pet food store transaction can result in a dog's “woof” sound. This may make more sense to the user if he or she owns a dog rather than a cat, bought dog food and not cat food, and is initially confused by the “meow” sound.

Alternatively, if the user refreshes or replays the web page or resource, a different transaction or set of transactions can be listed or played. For example, upon a refresh the user's last department store purchase can be listed instead of the pharmacy or pet store purchase.

Another embodiment is directed toward a method of providing authentication verification of a message. The method includes selecting a subset of transactions from a payment card account of a user, providing a uniform resource locator (URL) link to an authentication verification page, and displaying on the authentication verification page details of the at least one transaction in response to a request to access the URL through the link, thereby enabling a user to verify the authenticity of a message with which the URL link is sent.

Another embodiment is directed toward a method for a user or user's electronic device to authenticate a message from a sender. The method includes receiving a message with a link, selecting the link, and receiving a verification page in response to the selecting of the link. The verification page displays details of at least one transaction of an account of a user. The account is substantially private to the user. The method further includes checking the details of the at least one transaction, thereby authenticating the message from a sender.

Another embodiment is directed toward a method of establishing authenticity of a message, the method including selecting at least one transaction from a plurality of transactions of an account, the account being substantially private to a user, correlating a stock image, sound, or video to the selected at least one transaction, and presenting the image, sound, or video along with a message to the user, thereby enabling the user to verify the authenticity of the message.

Other embodiments of the invention include computer readable media including code executable by a processor that can implement the above methods. Yet other embodiments of the invention include computers or systems including the computer readable media.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates a web page in a browser having an electronic correspondence in accordance with an embodiment.

FIG. 2 illustrates an authentication verification page in accordance with an embodiment.

FIG. 3 illustrates an authentication verification page in accordance with another embodiment.

FIG. 4 illustrates an authentication verification page in accordance with another embodiment.

FIG. 5 illustrates an authentication verification page in accordance with another embodiment.

FIG. 6 is a table of transactions in an account in accordance with an embodiment.

FIG. 7 is a process diagram in accordance with an embodiment.

FIG. 8 illustrates the presentation of a sound along with a telephone message in accordance with an embodiment.

FIG. 9 illustrates the presentation of a sound along with an email message in accordance with an embodiment.

FIG. 10 is a flowchart illustrating a process in accordance with an embodiment.

FIG. 11 is a flowchart illustrating a process in accordance with an embodiment.

FIG. 12 is a flowchart illustrating a process in accordance with an embodiment.

FIG. 13 is a flowchart illustrating a process in accordance with an embodiment.

FIG. 14 shows a block diagram of a system that can be used in some embodiments of the invention.

FIG. 15 shows a block diagram of an exemplary computer apparatus.

The figures will now be used to illustrate different embodiments in accordance with the invention. The figures are specific examples of embodiments and should not be interpreted as limiting embodiments, but rather exemplary forms and procedures.

### DETAILED DESCRIPTION

Embodiments in accordance with the present disclosure generally relate to sending a unique link, such as a unique URL, with an electronic correspondence, such as an email. If the recipient of the correspondence has doubts about whether the correspondence truly came from the professed sender, the recipient can follow the link to bring up a verification resource, such as a web page, image, sound, or video file, etc. The resource correlates to one or more transactions, such as purchases, that a user has made in a substantially private account, such as a credit card account. By presenting resources that correspond to randomly selected transactions in a substantially private account with which the general public is not privy, the system allows the recipient to verify that the correspondence truly came from the sender and not a phisher.

In some embodiments, the unique URL link corresponds to a credit or debit card account which is serviced by a payment processing company, such as Visa. A few (e.g. three) past transactions of the account are selected from a database of the payment processing company and their details (e.g. date, amount, and merchant name) presented to the user.

A technical advantage of using a payment processing company's database for transactions is that transactions from cards issued by different banks under the same network branding can be used to present a cohesive front to the user. For example, transactions from a user's Wells Fargo debit card account and transactions from the user's Bank of America credit card account can be used for verification. It is generally more difficult for a phisher to hack into two accounts of two different banks than it is to access one account of one bank.

### I. Terms

A “resource” includes any file, software structure, or other construct that can provide content when properly accessed or followed. Static computer files, such as a hypertext markup language (HTML) web page, Joint Photographic Experts Group (JPEG) image file, Moving Picture Experts Group (MPEG) video file, and MPEG-1 Audio Layer 3 (MP3) sound file, can all be resources. Dynamic files, such as an Active Server Page (ASP), and placeholder files which redirect to another file with content can be resources. Some resources can be accessed by a uniform resource locator (URL) link on a networked or standalone electronic device.

A “type of resource” or “resource type” is the kind of resource. For example, a sound file can be a type of resource. As another example, a sound file and a static web page are different types of resources. A file extension can indicate, but is not always determinative, of the content or resource type held by a file.

A “substantially private” account includes an account to which the general public at large does not have access or which has secret, confidential, embarrassing, sensitive, or otherwise private information to an account holder or set of account holders. A bank account, credit or debit card account, retirement account, investment account, or other financial account can be said to be substantially private to an account holder. A substantially private account includes such financial accounts in which members of one's family or household have access. A substantially private account includes such financial accounts in which an employee makes purchases, an employer pays for, and co-workers have access, but are not open to the world at large.

A substantially private transaction includes a transaction that is not known by or publicized to the general public. A substantially private transaction includes normal credit card transactions for which a financial institution is bound by law to keep confidential. For example, a substantially private transaction includes a transaction known only to the account holder, the account holder's financial institution, and the merchant with whom the transaction was made. A substantially private transaction also includes a transaction that an account holder's spouse, relatives, or friends have knowledge of, such as payment for a dinner among friends.

A “verification page” is a web page or other page having content or other data that can be used to verify the authenticity of another page or other data.

The adverb, “randomly,” includes pseudo-randomly. Pseudo-random generators are often implemented in hardware or software on computers and are accessible through modern programming languages. Pseudo-random selections can include algorithmic selections which appear on the surface to be random but are mathematically deterministic. For example, the function rand( ) is available in the C programming language through the stdlib.h library, and selections using the rand( ) function are considered randomly selected.

“Correlating” an image, sound, or video to a transaction can include employing algorithms, such as keyword matchers, to detect whether the image, sound, or video is relevant to the transaction. For example, a transaction with a merchant having “Pet Store” in its name can be parsed to identify the word “pet,” synonyms such as “cat” can be looked up for “pet,” and then sound files can be searched for the word “cat” to find “cat meow.wav.” Other correlation algorithms are known in the art and would be apparent to one skilled in the art.

A “correspondence” or other message can be an electronic correspondence such as an instant message (IM), a short message service (SMS) message, an enhanced messaging service (EMS), a multimedia messaging service (MMS) message, a TWEET® message, an email as shown in the exemplary embodiment, or any other electronic correspondence. The correspondence can also be non-electronic, such as a paper letter. The correspondence generally can include any type of message which could otherwise emanate from a fraudulent source.

A “stock” image, sound, or video includes such images, sounds or videos that are typically indexed, edited to be about the same dimensions or length to each other, and whose rights are relatively freely available. For example, stock images include clip art available in Microsoft Word.

### II. Discussion of Embodiments

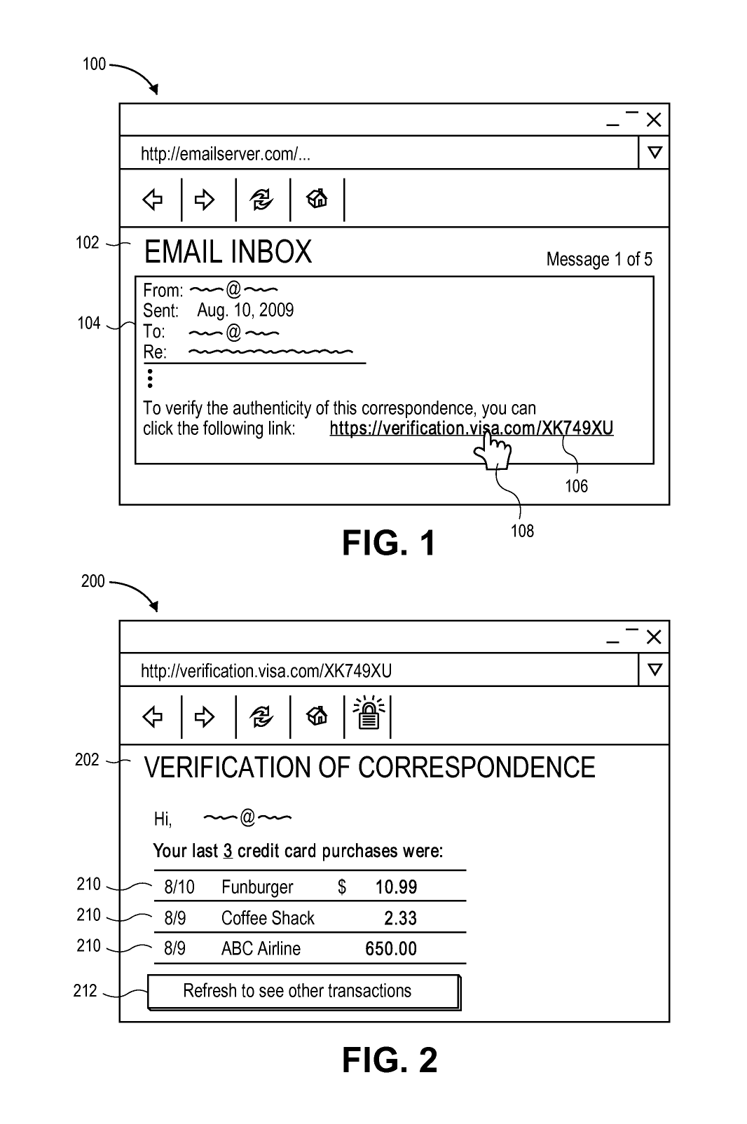

FIG. 1 illustrates a web page having an electronic correspondence in accordance with an embodiment. The figure shows web browser application window 100 with email inbox web page 102. Correspondence 104 is shown inside the browser window. The correspondence shows from whom the correspondence was supposedly sent. As is the case in many emails, some “From” fields are fraudulently altered by phishers so that they appear to come from a legitimate contact when, in fact, they are not authentic. The exemplary message is from a legitimate source.

The correspondence has link 106 to a uniform resource locator (URL) embedded after the end of the message. The link's anchor text reads “To verify the authenticity of this correspondence, you can click the following link: https://verification.visa.com/XK749XU”. If the user reading the message wants to confirm the authenticity of the message, he or she can click on the link. In some embodiments, the link is to a secure, trusted domain with a valid server side certificate.

Clicking on the link with cursor 108 brings up an authentication verification page. The authentication verification page can be in a new window or it can stay in the same browsable window that showed the message and link.

FIG. 2 illustrates web browser window 200 showing an authentication verification page 202. The authentication verification page can include a personal greeting as shown or other data that may give added security to the page. The exemplary authentication verification page shows three different and distinct transactions 210: (1) a meal purchase, (2) a coffee purchase, and (3) a travel purchase. For each transaction, the exemplary embodiment shows the date, merchant name, and amount of the debit or credit to the card. This detailed transaction data was looked up from a database of the payment processing company that services the account holder's credit card. The transaction data also could have been looked up from the financial institution through which the card was issued. Generally, only the account holder, account holder's financial institution, and payment processing company are privy to the account holder's transaction data. Because the transaction data is generally confidential, an account holder who checks the data can be reasonably sure that no one masquerading as the message sender could have sent the message, thereby ensuring that the message was truly sent from the professed source.

The data displayed can be varied every time the user visits the verification page in order to provide additional safety. This transaction data (contextual information) would only be known to the user's financial institution and card servicing company. Varying the contextual information could prevent discovery by social engineering and other identity theft attacks. The same link in the correspondence may supply different transaction data each time it is clicked in case the consumer does not recognize the initial transactions. In the link itself, there is no personally identifiable information. Therefore, if the link is viewed by someone other than the intended consumer, no exploitable information would be provided.

Kanevsky et al. (U.S. Pat. No. 5,774,525 issued Jun. 30, 1998) describes authentication questions asked by a service provider (e.g. an Automated Teller machine (ATM) network) of a user in order to authenticate a user. The questions can include a history of credit card purchases made by the user. Barrett et al. (U.S. Pat. No. 7,143,095 issued Nov. 28, 2006) discloses questioning a user regarding previous purchases to verify the user's identity. Kanevsky's and Barrett's systems question a user about his own credit card purchases in order to verify the user's identity instead of presenting credit card or other transactions to the user in order to confirm to the user that the system is not a phishing scam. With a computer calculating whether a user's answers are correct as in Kanevsky or Barrett, the matter is simplistically black and white. Either the user is given access, or the user is not given access. This does not facilitate a message recipient's assessment of whether to trust the message. Furthermore, there is no link embedded in a correspondence or message upon which a recipient may voluntarily go in order to authenticate a message. The user must answer the questions or be denied access.

A user may not recognize the transactions shown or may not recognize the transactions presented. Refresh buttons 212 and/or 214 can be pressed to present a set of other transactions from the account. A limit can exist on the number of times that the refresh button can be pressed. For example, a user may be limited to refresh the transactions list a maximum of three times. This limit can help with the compartmentalization and containment of confidential transaction data in case a phisher were to intercept the message and use the link to gain information about the user.

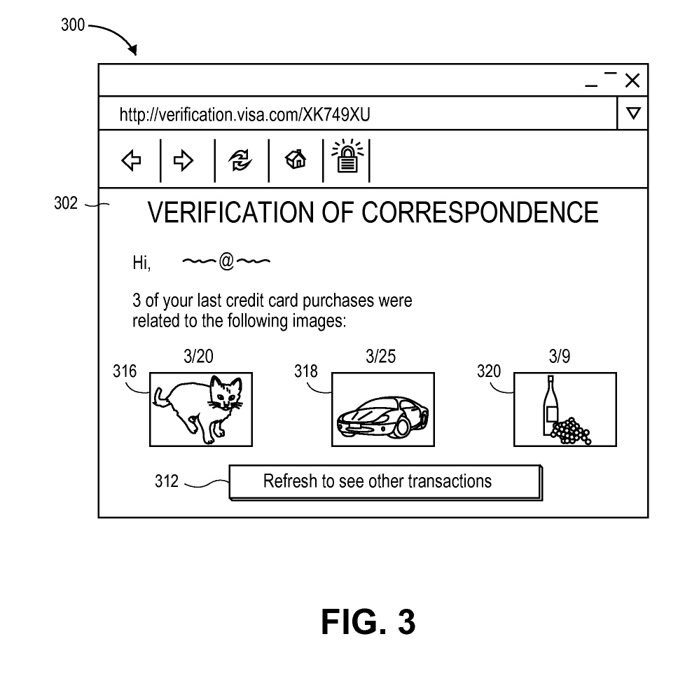

FIG. 3 illustrates web browser window 300 showing authentication page 302. This authentication page shows stock images 316, 318, and 320 that were correlated to three different transactions. Image 316 was correlated to a purchase from a pet store, image 318 was correlated to a purchase of gasoline, and image 320 was correlated to a tasting fee at a winery. For each transaction there is a single image, but multiple images for each transaction can also be correlated and shown at the same time or at different times (e.g. upon a refresh). Button 312 can be pressed to present images correlated to another, different set of transactions than the pet store, gasoline, and winery transactions.

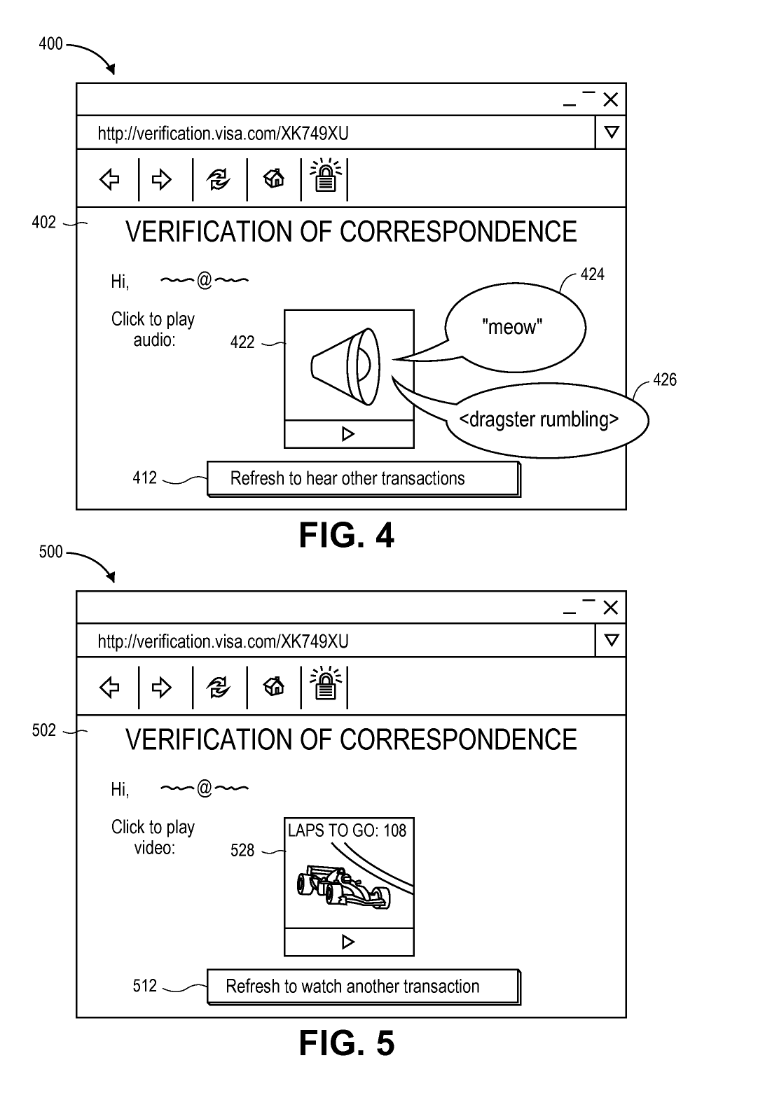

FIG. 4 illustrates web browser window 400 showing authentication page 402. This authentication page shows sound icon 422 that when clicked causes a correlated sound to play. Sound 424, the sound of a cat meowing, was correlated to a purchase from a pet store, and sound 426, the sound of a dragster rumbling, was correlated to a purchase of tickets for automotive racing. One sound can be played at a time, or the sounds can be played one after another in sequence. Button 412 can be pressed to present sounds correlated to another, different set of transactions than the pet store and automotive racing transactions.

FIG. 5 illustrates web browser window 500 showing authentication page 502. The authentication page shows video 528 of a car race. Video 528 was correlated to a user's purchase of tickets for automotive racing. Multiple videos can be played at once in different parts of the screen (not shown) or one after another in sequence. Button 512 can be pressed to present videos correlated to a different transaction than the automotive racing transaction in the user's account.

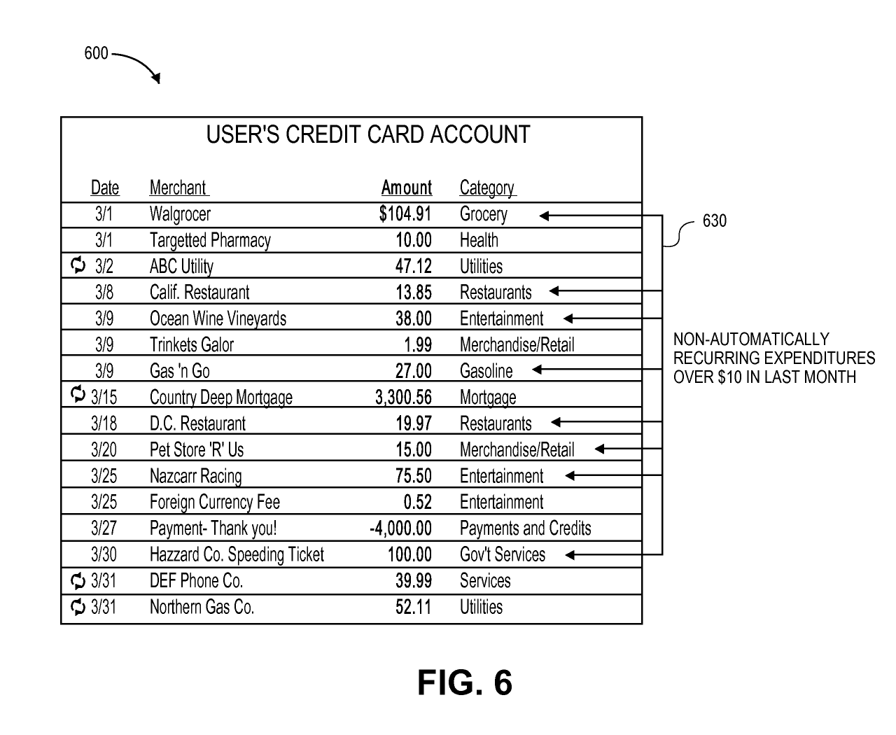

FIG. 6 shows table of transactions 600 in a credit card account in the month of March. Shown are transactions relating to purchases of groceries, medicine, utilities, etc. The third transaction is an automatically recurring transaction set up by the account holder to automatically pay his or her monthly utility bill, as indicated by the reoccurrence icon. A payment of a credit card bill is shown as a credit on March 27.

Transactions can include purchases, debits, credits, refunds, automated teller machine (ATM) withdrawals, money transfers, zero-money transfers, and other line items in an account. The transactions can be stored in a database or as otherwise known in the art.

A transaction for which transaction data is listed in an authentication page can be selected from a database of accounts in many ways. For example, the transaction can be selected at random, or it can be pseudo-randomly or non-randomly selected. The transaction can be randomly selected within a particular range, such as within the last week or month. The transaction can be limited to certain types of transactions, such as those conducted with a particular merchant or within a particular merchant category code (MCC) or North American Industry Classification System (NAICS) category. The transaction can be limited to refunds only or can encompass purchases and refunds.

It can be preferable in some embodiments that any restriction on the selection of a transaction does not limit the candidate pool of transactions to one that is too small. It is more preferable, but not required, for restrictions to result in a larger pool of transactions. For example, limiting the selectable transactions to only the purchase of airline tickets in the last year might limit the pool of transactions to 3 or 4 transactions for some non-business travelers. Limiting the selectable transactions to any purchases except for recurring phone bill payments offers a larger pool of transactions. In some embodiments it is desirable to have between two to ten transactions so that there are enough transactions to verify that they indeed are from the authentic source but not so many transactions as to overwhelm a user. In other embodiments, between three to five transactions can be optimal because humans often comprehend things in sets of three, four, or five. In still other embodiments, there can be a random (i.e. pseudorandom) number of transactions listed between one and eight so as to introduce more complexity into the process and be less easily spoofed. The number of transactions listed can also be a number selected during enrollment or at other times by the user.

Restrictions on the candidate pool of transactions from which a selection can be made can be adaptive. One may start with a certain set of restrictions, and then lessen or shift the restrictions if the pool is too small. For example, a default account may have the restrictions of including only transactions within the last month for restaurants, food, and clothing purchases. If there are few (e.g. 2, 3, or more) transactions in the pool for a particular person, some of the restrictions may be relaxed. For example, the restrictions may be opened up to allow the last two months of restaurants, food, and clothing purchases to be considered. An another example, the restrictions may be opened up to allow the last month of all transactions to be considered.

In some embodiments, the transaction pool is made to include transactions that are more easily remembered. Not only can the transaction pool include those transactions in the last month, but also the first month of having the account because people often remember items at the beginning and end of lists better than the middle of lists, all things being equal. People sometimes can remember things better that involve large, immersive changes, and this can be used to an advantage in some embodiments. For example, transactions that involve vacation travel to a different country can be candidates for the pool. If a transaction occurs in a different country than the cardholder's country of residence, then the transaction may be elevated into the pool.

A transaction pool can also be selected so that it avoids transactions that are more difficult to remember. For example, recurring transactions, such as the automatic payment of a telephone bill, may be purged from the pool. The transaction pool can be selected to avoid invoking painful or embarrassing memories. For example, transactions involving trips to doctors, dentists, clinics, or other health care providers may be eliminated from the pool. Transaction pool restrictions can also be user-selected. For example, the account holder may specify that only concert and music purchases be put in the pool. A user may specify this through an enrollment procedure.

Transaction pool 630 is a selection of non-automatically recurring expenditures, each over $10, within the last month. Transaction pool 630 includes more easily remembered transactions such as wine tasting and car racing but also includes less memorable trips to the grocery store and gas station. Excluded from transaction pool 630 are mundane purchases such as recurring phone, gas, and utility bills, foreign currency fees and small transaction amounts, as well as payments of a previous credit card bill.

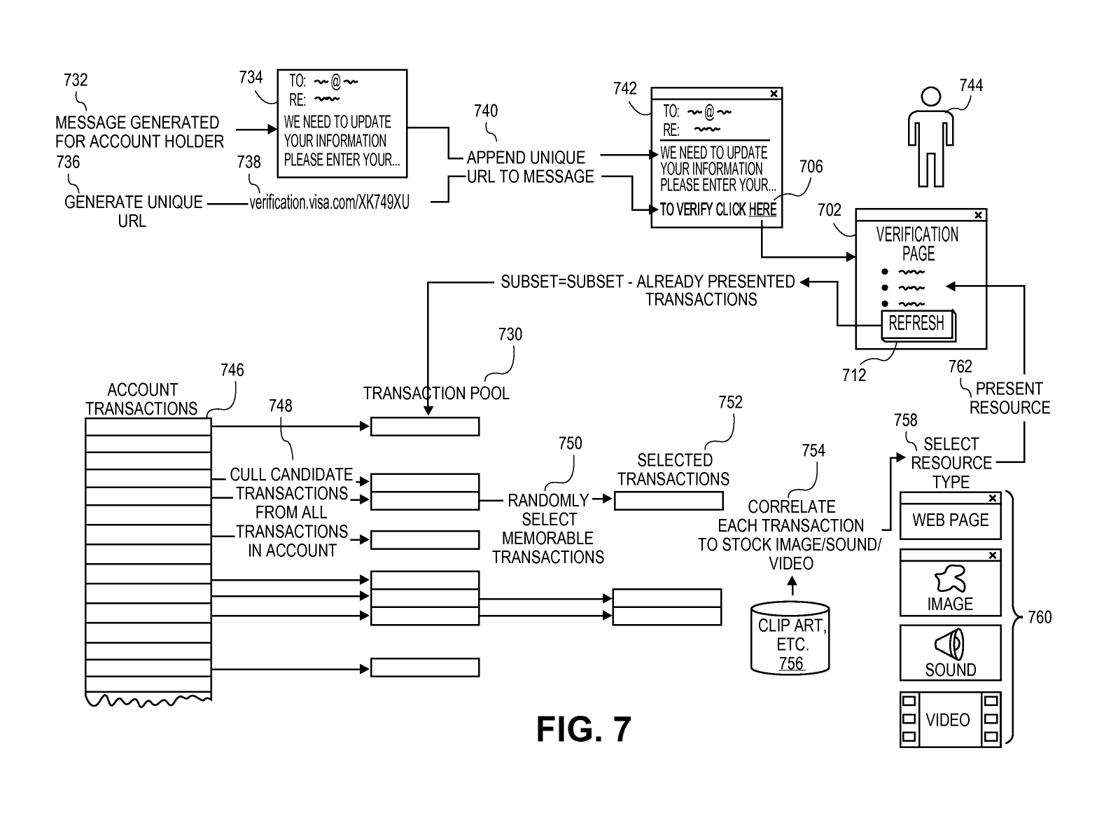

FIG. 7 is a process diagram in accordance with an embodiment. In process 732, message 734 is generated for an account holder. In process 736, unique URL 738 is generated. A “unique” URL can be unique to only a local network or be universally unique throughout the Internet. The URL can be unique for a short amount of time or a longer period. The URL can include a domain name, generic top-level domain (gTLD), directory, and/or filename of a resource.

In process 740, unique URL 738 is appended to message 734 and the message and URL pair 742 are sent to user 744. If the user doubts the authenticity of the message, he can follow link 706 to bring up a verification page 702.

In one embodiment, the message and URL are not electronic. The verification ‘link’ is an toll-free 800 telephone number and 12-digit code printed on a paper mailing. Dialing the telephone number and entering the code results in an automated voice at the other end reading data derived from the last few transactions of the account.

To populate verification page 702, account transactions 746 are culled in process 748 to identify candidate transactions for transaction pool 730 by restricting out non-memorable transactions.

Transactions are then randomly selected in process 750 from candidate transaction pool 730. An attempt is made in process 754 to correlate each transaction of selected transactions 752 to a stock image, sound, and/or video from database 756.

In process 758, resource type 760 (e.g. web page, image, sound, video file) is selected based upon the transaction and/or based upon the correlated resource. For example, if a transaction was a purchase of medicine, then a web page simply listing the transaction may be appropriate. If the transaction was for automotive racing, then a video may be more appropriate.

The quality of the correlation, indicated by a correlation quality number, may also be used to determine which resource type is presented to a user. For example, an image of a cat may correlate well with a purchase from a pet store and give a correlation quality of 90%. However, if no image in the database correlates well with the purchase such that the highest correlation quality number with an image is below 50%, then the resource type may be switched to a web page with no image.

In process 762 the selected resource is presented to user 744 through verification page 702. The presentation can include a simple text listing of transaction details, displaying of images, or playing of correlated sounds or videos.

If refresh button 712 is depressed, then a different, random set of transactions from transaction pool 730 can be selected in process 764. The different set of transactions does not include the transaction or transactions that were previously presented to the user.

Transaction data does not need to be written to be communicated to the account holder. The transaction data can be communicated orally, by brail or sign language, be videotaped, etc.

In some embodiments, a user does not click a link to have the verification data of his account presented; instead, correlated sounds, images, or video are automatically presented to the user with the message.

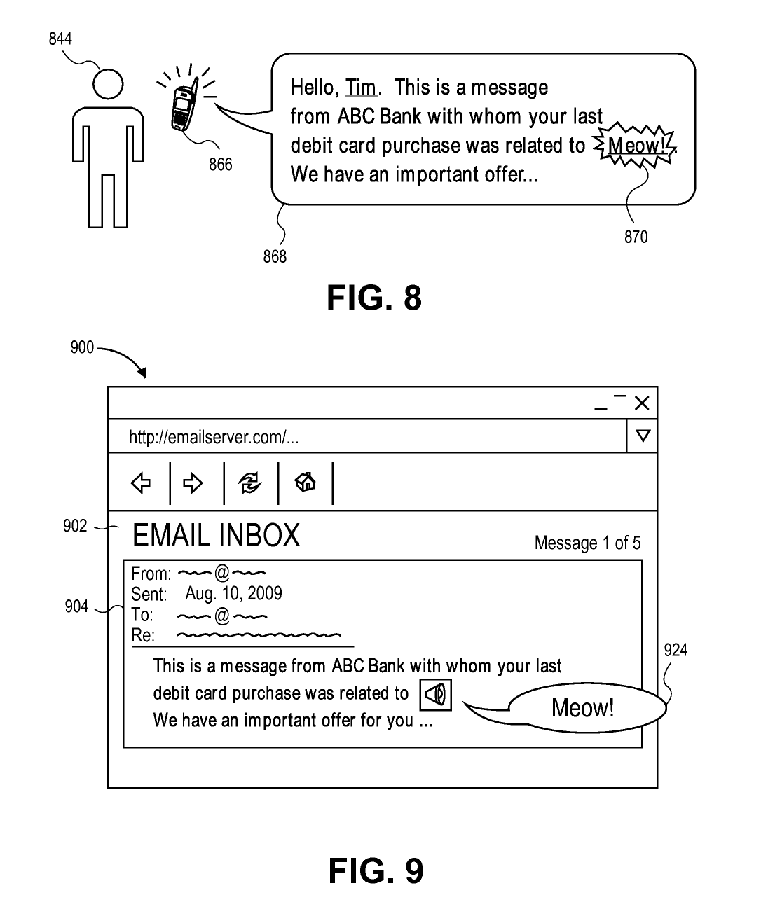

FIG. 8 illustrates the presentation of a sound along with a telephone message in accordance with an embodiment. User 844 listens to voice message 868 on phone 866. Voice message 868 includes correlated sound 870, the sound of a cat meowing, to imply that the message is genuine. In this case, user 844 may recognize that his last debit card purchase was from a pet store, and thus the message is genuinely from his bank.

FIG. 9 illustrates the presentation of a sound along with an email message in accordance with an embodiment. The figure shows web browser application window 900 with email inbox web page 902. Correspondence 904 is shown inside the browser window. In this embodiment a correlated sound 924 automatically plays while viewing the email without user selection.

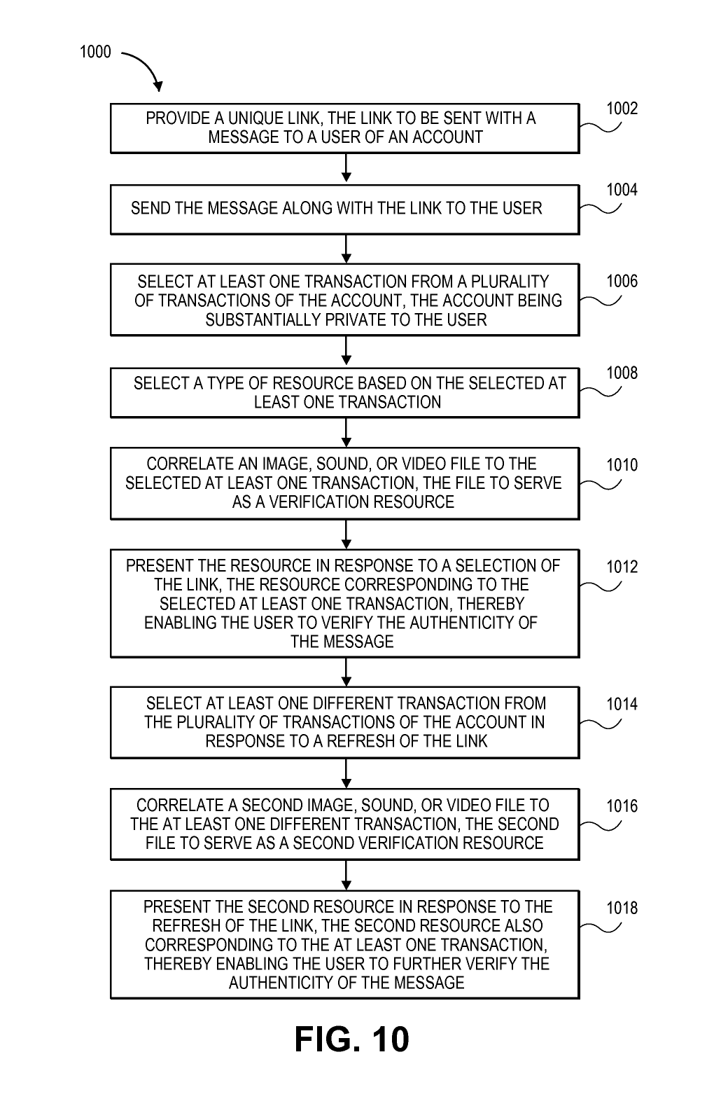

FIG. 10 is a flowchart illustrating a process in accordance with an embodiment. This process, process 1000, can be automated in a computer or other machine. The process can be coded in software, firmware, or hard coded as machine-readable instructions and run through a processor that can implement the instructions. In operation 1002, a unique link to be sent with a message to a user of an account is provided. In operation 1004, the message is sent along with the link to the user. In operation 1006, at least one transaction is selected from a plurality of transactions of the account. The account is substantially private to the user, such as a financial account. In operation 1008, a type of resource is selected based on the selected at least one transaction. In operation 1010, an image, sound, or video file is correlated to the selected at least one transaction. The correlated file serves as a verification resource. In operation 1012, the resource is presented in response to a selection of the link. The resource corresponds to the selected at least one transaction, thereby enabling the user to verify the authenticity of the message.

In operation 1014, at least one different transaction is selected from the plurality of transactions of the account in response to a refresh of the link. In operation 1016, a second image, sound, or video file is correlated to the at least one different transaction. The second file serves as a second verification resource. In operation 1018, the second resource is presented in response to the refresh of the link. The second resource also corresponds to the at least one different transaction, thereby enabling the user to further verify the authenticity of the message.

The operations can be performed in the order shown above or in any suitable order. For example, an image can be correlated to a transaction before or after it is decided which resource type to present.

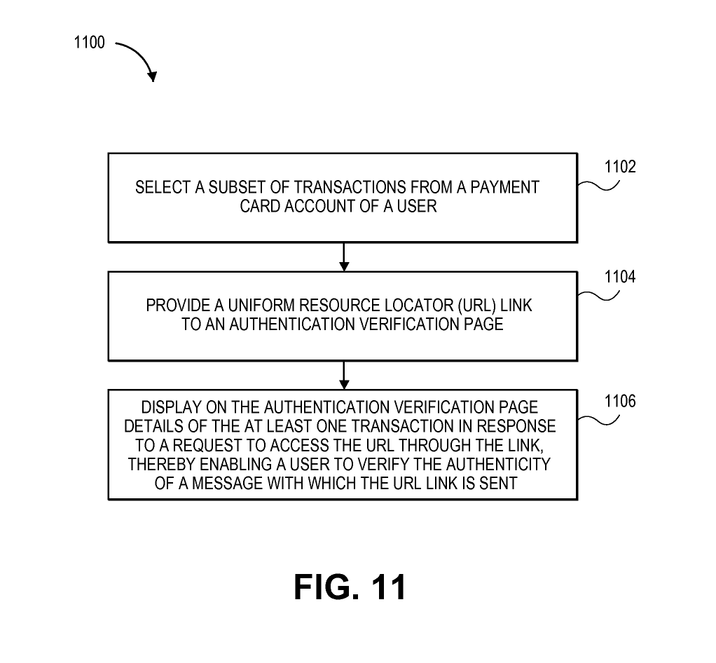

FIG. 11 is a flowchart illustrating a process in accordance with an embodiment. In operation 1102, a subset of transactions from a payment card account of a user is selected. In operation 1104, a uniform resource locator (URL) link to an authentication verification page is provided. It is not required for the verification page to exist at the time the link is provided. In operation 1106, details of the at least one transaction are displayed on the authentication verification page in response to a request to access the URL through the link, thereby enabling a user to verify the authenticity of a message with which the URL link is sent.

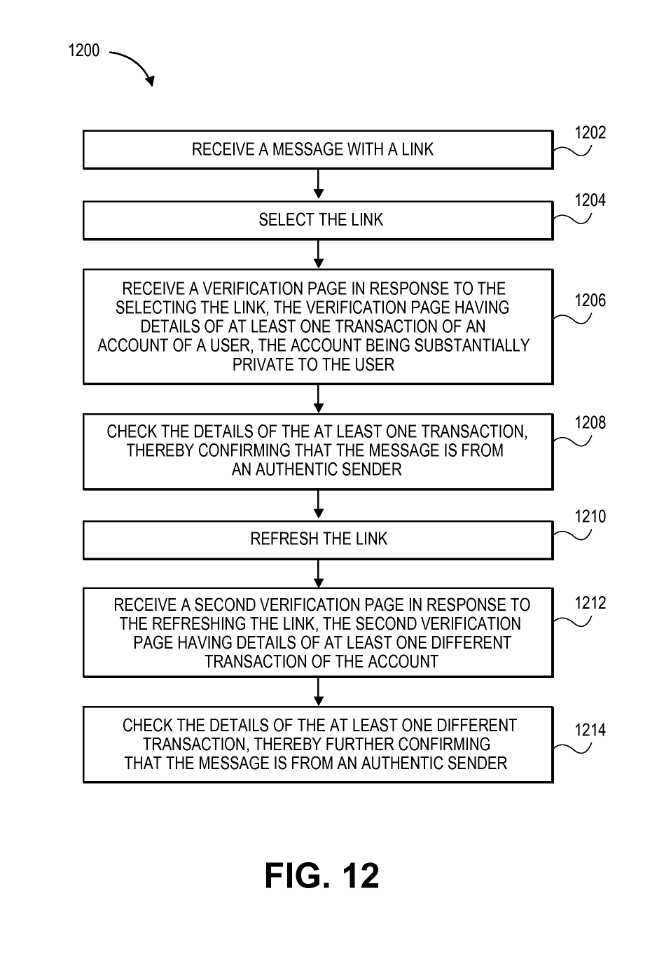

FIG. 12 is a flowchart illustrating a process in accordance with an embodiment. In operation 1202, a message is received with a link, and in operation 1204, the link is selected. In operation 1206, a verification page is received in response to the selecting of the link. The verification page has details of at least one transaction of an account of a user. The account is substantially private to the user. In operation 1208, the details of the at least one transaction are checked, thereby confirming that the message is from an authentic sender.

In operation 1210, the link is refreshed. In operation 1212, a second verification page is received in response to the refreshing the link. The second verification page has details of at least one different transaction of the account. In operation 1214, the details of the at least one different transaction are checked, thereby further confirming that the message is from an authentic sender.

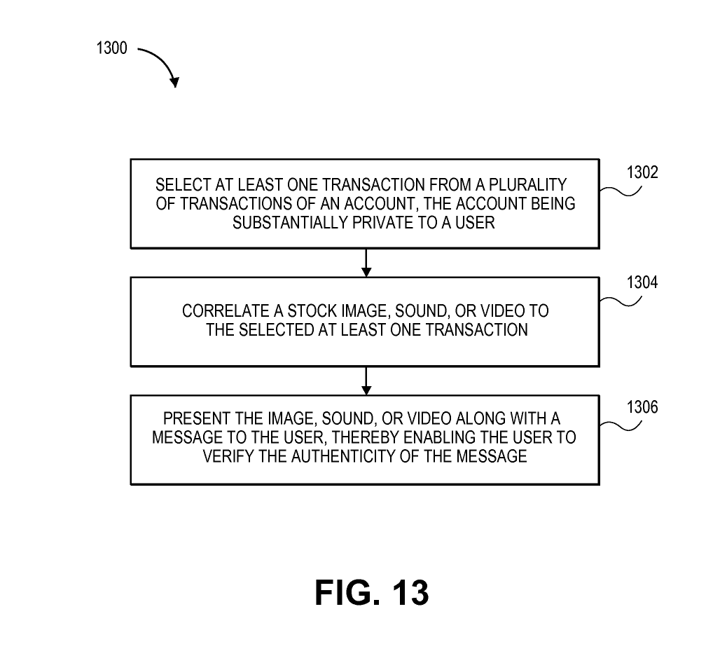

FIG. 13 is a flowchart illustrating a process in accordance with an embodiment. In operation 1302, at least one transaction is selected from a plurality of transactions of an account. The account is substantially private to a user, such as a financial account. In operation 1304, a stock image, sound, or video is correlated to the selected at least one transaction. In operation 1306, the correlated image, sound, or video is presented along with a message to the user, thereby enabling the user to verify the authenticity of the message.

### III. Obtaining Transaction Data

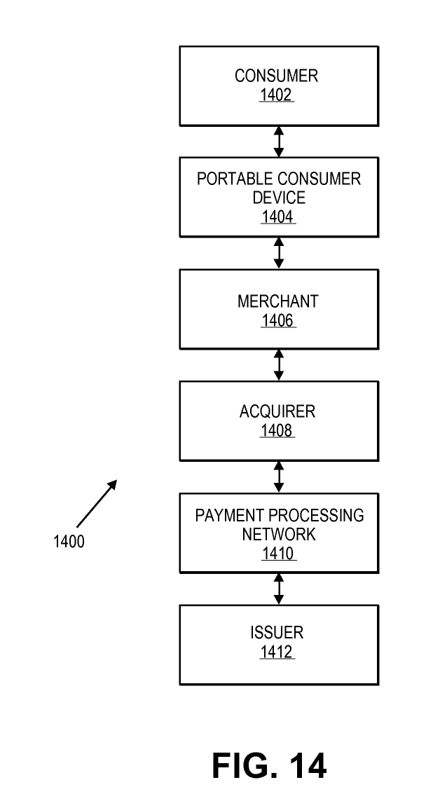

The transaction data can be obtained in any suitable manner. The transaction data can be generated using the system shown in FIG. 14. The system 1400 includes merchant 1406 and acquirer 1408 (e.g. a bank) associated with merchant 1406. In a typical payment transaction, consumer 1402 may purchase goods or services at the merchant 1406 using portable consumer device 1404. Acquirer 1408 can communicate with issuer 1412 (e.g. another bank) via payment processing network 1410.

Consumer 1402 may be an individual, or an organization such as a business that is capable of purchasing goods or services.

The portable consumer device 1404 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like. The portable consumer devices can also be debit devices (e.g., a debit card), credit devices (e.g., a credit card), or stored value devices (e.g., a stored value card).

Payment processing network 1410 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

Payment processing network 1410 may include a server computer. A server computer is typically a powerful computer or cluster of computers. For example, the server computer can be a large mainframe, a minicomputer cluster, or a group of servers functioning as a unit. In one example, the server computer may be a database server coupled to a web server. Payment processing network 1410 may use any suitable wired or wireless network, including the Internet.

Merchant 1406 may also have, or may receive communications from, an access device that can interact with portable consumer device 1404. The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with portable consumer devices 1404.

In a typical purchase transaction, consumer 1402 purchases a good or service at merchant 1406 using a portable consumer device 1404 such as a credit card. The consumer's portable consumer device 1404 can interact with an access device such as a POS (point of sale) terminal at merchant 1406. For example, consumer 1402 may take a credit card and may swipe it through an appropriate slot in the POS terminal. Alternatively, the POS terminal may be a contactless reader, and portable consumer device 1404 may be a contactless device such as a contactless card.

An authorization request message is then forwarded to acquirer 1408. After receiving the authorization request message, the authorization request message is then sent to payment processing network 1410. Payment processing network 1410 then forwards the authorization request message to issuer 1412 of the portable consumer device 1404.

After issuer 1412 receives the authorization request message, issuer 1412 sends an authorization response message back to payment processing network 1410 to indicate whether or not the current transaction is authorized (or not authorized). Transaction processing system 1410 then forwards the authorization response message back to acquirer 1408. Acquirer 1408 then sends the response message back to merchant 1406.

After merchant 1406 receives the authorization response message, the access device at merchant 1406 may then provide the authorization response message for consumer 1402. The response message may be displayed by the POS terminal, or may be printed out on a receipt.

At the end of the day, a normal clearing and settlement process can be conducted by transaction processing system 1410. A clearing process is a process of exchanging financial details between and acquirer and an issuer to facilitate posting to a consumer's account and reconciliation of the consumer's settlement position. Clearing and settlement can occur simultaneously.

The transaction data can be captured by payment processing network 1410, and a computer apparatus in the payment processing network (or other location) may process the transaction data as described in this application. The captured transaction data can include data including, but not limited to: the amount of a purchase, the merchant identifier, the location of the purchase, whether the purchase is a card-present or card-not-present purchase, etc.

The various participants and elements in the figure may operate one or more computer apparatuses to facilitate the functions described herein. Any of the elements in the figure may use any suitable number of subsystems to facilitate the functions described herein. Further, the computer apparatus can be used to randomly select transactions, correlate stock images, sounds, and/or video to the selected transactions, store information about such correlations, and play or otherwise present the correlated resources.

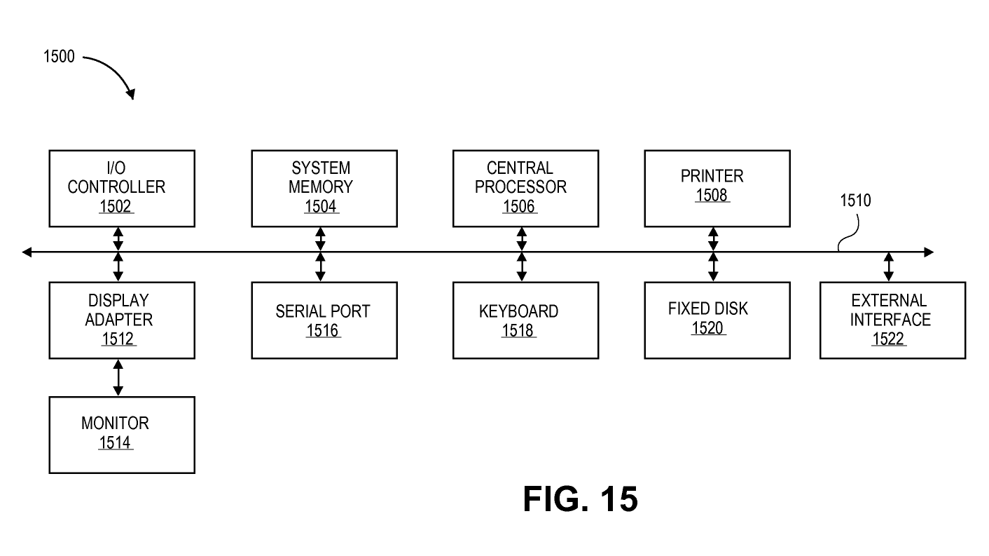

Examples of subsystems or components of such computer apparatuses are shown in FIG. 15. The subsystems shown in the figure are interconnected via a system bus 1510. Additional subsystems such as a printer 1508, keyboard 1518, fixed disk 1520 (or other memory comprising computer readable media), monitor 1514, which is coupled to display adapter 1512, and others are shown. Peripherals and input/output (I/O) devices, which couple to I/O controller 1502, can be connected to the computer system by any number of means known in the art, such as serial port 1516. For example, serial port 1516 or external interface 1522 can be used to connect the computer apparatus to a wide area network such as the Internet, a mouse input device, or a scanner. The interconnection via system bus allows the central processor 1506 to communicate with each subsystem and to control the execution of instructions from system memory 1504 or the fixed disk 1520, as well as the exchange of information between subsystems. The system memory 1504 and/or the fixed disk 1520 may embody a tangible computer readable medium.

Embodiments of the invention are not limited to the above-described embodiments. For example, although separate functional blocks are shown for an issuer, payment processing network, and acquirer, some entities perform all of these functions and may be included in embodiments of invention.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of providing authentication verification for a message, the method comprising:
providing a unique link, the link to be sent with a message to a user of an account;
selecting, using a processor operatively coupled to a memory, at least one transaction from a plurality of transactions of the account, the account being substantially private to the user; and
presenting a resource in response to a selection of the link, the resource corresponding to the selected at least one transaction, thereby enabling the user to verify the authenticity of the message.

2. The method of claim 1 further comprising:
selecting at least one different transaction from the plurality of transactions of the account in response to a refresh of the link; and
presenting a second resource in response to the refresh of the link, the second resource also corresponding to the selected at least one different transaction, thereby enabling the user to further verify the authenticity of the message.

3. The method of claim 1 further comprising:
selecting a type of resource based on the selected at least one transaction.

4. The method of claim 1 wherein:
the resource is an authentication verification web page with transaction data from the at least one transaction; and
presenting includes displaying the authentication verification web page.

5. The method of claim 1 further comprising:
correlating an image to the selected at least one transaction, wherein the resource is an image file of the image and presenting includes displaying the image.

6. The method of claim 1 further comprising:
correlating a sound to the selected at least one transaction, wherein the resource is an audio file of the sound and presenting includes playing the audio.

7. The method of claim 1 further comprising:
correlating a video to the selected at least one transaction, wherein the resource is a video file of the video and presenting includes playing the video.

8. The method of claim 1 wherein the substantially private account is a financial account of the user and the transactions are financial transactions.

9. The method of claim 8 wherein the financial transactions are selected from the group consisting of debit card, credit card, and prepaid card transactions.

10. The method of claim 1 wherein the selecting is conducted randomly from a subset of the plurality of transactions.

11. The method of claim 10 wherein the subset includes transactions conducted within a time frame selected from the group consisting of the last week, last month, and last 90 days.

12. The method of claim 10 wherein the subset includes financial transactions greater than or equal to a predetermined amount of money.

13. The method of claim 10 wherein the subset excludes automatic reoccurring bill payments.

14. The method of claim 1 wherein the link is a uniform resource locator (URL).

15. The method of claim 1 wherein the message is electronic and a format of the electronic message is selected from the group consisting of an instant message (IM), a short message service (SMS) message, an enhanced messaging service (EMS), a multimedia messaging service (MMS) message, a TWEET® message, and an email.

16. The method of claim 1 wherein each operation is performed by a computer processor operatively coupled to a memory.

17. A machine-readable storable medium embodying information indicative of instructions for causing one or more machines to perform the operations of claim 1.

18. A computer system executing instructions in a computer program, the computer program instructions comprising program code for performing the operations of claim 1.

19. A method of providing authentication verification for a message, the method comprising:
selecting, using a computer processor operatively coupled to a memory, a subset of transactions from a payment card account of a user;
providing a uniform resource locator (URL) link to an authentication verification page; and
displaying on the authentication verification page details of the at least one transaction in response to a request to access the URL through the link, thereby enabling a user to verify the authenticity of a message with which the URL link is sent.

20. A method of authenticating a message from a sender, the method comprising:
receiving a message with a link;
selecting, using a processor operatively coupled to a memory, the link;
receiving a verification page in response to the selecting the link, the verification page having details of at least one transaction of an account of a user, the account being substantially private to the user; and
checking the details of the at least one transaction, thereby confirming that the message is from an authentic sender.
